(19) United States
(12) Patent Application Publication
(10) Pub. No.: US 2011/0153341 A1
(43) Pub. Date: Jun. 23, 2011

(54) METHODS AND SYSTEMS FOR USE OF AUGMENTED REALITY TO IMPROVE PATIENT REGISTRATION IN MEDICAL PRACTICES

(75) Inventor: Alejandro Diaz-Cortes, Hillsboro, OR (US)

(73) Assignee: GENERAL ELECTRIC COMPANY, Schenectady, NY (US)

(21) Appl. No.: 12/640,950

(22) Filed: Dec. 17, 2009

(51) Int. Cl. G06Q 50/00; G06K 9/00; G09G 5/00; G06Q 10/00

(52) U.S. Cl. 705/2; 382/118; 345/629; 345/1.3; 348/77

(57) ABSTRACT

Certain examples provide systems and methods for patient identification. Certain examples provide a patient identification system. The patient identification system includes a data storage to store patient information including patient identifying information associated with one or more patient images and a processor adapted to facilitate identification of a patient. The processor is to receive a camera feed including an image of a patient; perform facial recognition using the camera feed to identify the patient in comparison with information stored in the data storage; retrieve information associated with the identified patient from the patient storage; display the retrieved information in conjunction with the image of the identified patient on a computer screen; and facilitate an electronic action with respect to the identified patient via the computer.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Patient identification can often be difficult and time consuming for a receptionist. Healthcare expense leads some patients to fraudulently claim another's identity, thereby threatening another's healthcare coverage and adding additional burden on the country's healthcare system.

Lack of familiarity or recognition can also create distance or uncertainty between the patient and healthcare facility staff. Such lack of familiarity can result in a restricted flow of information from the patient and potentially less robust diagnosis and/or treatment of the patient at the facility.

### BRIEF SUMMARY

Certain examples provide systems and methods for patient identification. Certain examples provide a patient identification system. The patient identification system includes a data storage to store patient information including patient identifying information associated with one or more patient images and a processor adapted to facilitate identification of a patient. The processor is to receive a camera feed including an image of a patient; perform facial recognition using the camera feed to identify the patient in comparison with information stored in the data storage; retrieve information associated with the identified patient from the patient storage; display the retrieved information in conjunction with the image of the identified patient on a computer screen; and facilitate an electronic action with respect to the identified patient via the computer.

Certain examples provide a computer-implemented method for patient identification. The method includes receiving, using a processor, an image feed from a camera including an image of a patient; performing, using a processor, facial recognition using the image feed to identify the patient in comparison with information stored in a data storage, wherein the image feed data is transformed into a patient identification; retrieving, using a processor, information associated with the identified patient from the patient storage; displaying, using a processor, the retrieved information in conjunction with the image of the identified patient on a computer screen; and facilitating, using a processor, an electronic action with respect to the identified patient.

Certain examples provide a computer-readable storage medium having a set of instructions stored thereon which, when executed, instruct a processor to implement a method for patient identification. The method includes receiving an image feed from a camera including an image of a patient; performing facial recognition using the image feed to identify the patient in comparison with information stored in a data storage, wherein the image feed data is transformed into a patient identification; retrieving information associated with the identified patient from the patient storage; displaying the retrieved information in conjunction with the image of the identified patient on a computer screen; and facilitating an electronic action with respect to the identified patient.

### BRIEF DESCRIPTION OF SEVERAL VIEWS OF THE DRAWINGS

FIG. 1 illustrates an example patient registration system using augmented reality and facial recognition to facilitate patient registration at a healthcare facility.

FIG. 2 illustrates an example healthcare facility.

FIGS. 3-6 show various monitor configurations using facial recognition and augmented reality for patient identification.

FIG. 7 shows a flow diagram for an example method for patient identification and registration.

FIG. 8 is a schematic diagram of an example processor platform that can be used and/or programmed to implement the example systems and methods described above.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Certain examples eliminate the problem of identifying an existing patient upon arrival at a healthcare facility. Certain examples streamline verification of patient identity using automated facial recognition and information retrieval. Certain examples provide an improved patient comfort level at the healthcare facility through streamlined identification and verification. Certain examples help eliminate check-in mistakes because receptionists can maintain eye contact with patients for longer periods of time. Since augmented reality functions with real time video, a receptionist can be sure of which patient he or she is checking in and working with at any time, for example.

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Certain examples use a combination of augmented reality and facial recognition to identify a patient when he or she enters into the receptionist's field of view at a healthcare facility, such as a doctor's office, clinic, hospital, etc. Once the patient is identified, information pertinent to the patient is displayed floating next to and/or otherwise in relation to the image of the patient's face on a display and/or on a secondary display to the side of the primary display, for example. When the receptionist uses a pointing device (e.g., a mouse, touchpad, trackball, scroll wheel, touchscreen, etc.) to select the patient on the user interface, the patient's information and/or a check-in screen is displayed allowing the receptionist to check the patient in without having to face away from the patient.

Certain examples provide a camera connected to a computer and facing a reception area at a healthcare facility. A receptionist sits behind a counter or desk facing the reception area as well and uses the computer workstation. The camera is connected to the computer with a display between the receptionist and the patient waiting or reception area. The video feed is presented in real time (or substantially real time) and shows the view from the receptionist's point of view. One or more face recognition application programming interfaces (APIs) identify the patient from an existing image database and retrieve patient data associated with the identified patient, for example.

Facial recognition system(s) and/or algorithm(s) automatically identify or verify a person from a digital image or a video frame from a video source. One way to identify the person is by comparing selected facial features from a captured image and a facial database, for example.

Some facial recognition algorithms identify faces by extracting landmarks, or features, from an image of the subject's face. For example, an algorithm can analyze the relative position, size, and/or shape of the eyes, nose, cheekbones, and jaw. These features are then used to search for other images with matching features. Other algorithms normalize a gallery of face images and then compress the face data, only saving the data in the image that is useful for face detection, for example. A probe image is then compared with the face data.

Recognition algorithms can be divided into two main approaches—1) geometric, which looks at distinguishing features or 2) photometric, which is a statistical approach that distills an image into values and compares the values with templates to eliminate variances, for example. Recognition algorithms include Principal Component Analysis with eigenface, Linear Discriminate Analysis, Elastic Bunch Graph Matching fisherface, Hidden Markov model, and neuronal motivated dynamic link matching, for example.

In another example, three-dimensional (3D) face recognition can be facilitated using 3D sensors to capture information about the shape of a face. This information is then used to identify distinctive features on the surface of a face, such as the contour of the eye sockets, nose, and chin. One advantage of 3D facial recognition is that it is not affected by changes in lighting and can identify a face from a range of viewing angles, including a profile view. Another example uses visual details of the skin, as captured in standard digital or scanned images. This technique, called skin texture analysis, turns the unique lines, patterns, and spots apparent in a person's skin into a mathematical space.

Augmented reality (AR) refers to a live direct or indirect view of a physical, real-world environment whose elements are merged with (or augmented by) virtual computer-generated imagery to create a mixed reality. Augmentation can occur in real-time (or substantially real time) and in semantic context with environmental elements. Artificial information about the environment and the objects in it can be stored and retrieved as an information layer on top of the real world view.

An augmented reality combination of live video stream(s) and data can be provided via a variety of display technologies including a monitor/screen, a head-mounted display, a virtual retinal display, etc. A Head Mounted Display (HMD) places images of both the physical world and registered virtual graphical objects over the user's view of the world. The HMDs can be optical see-through or video see-through in nature, for example. Handheld augmented reality employs a small computing device with a display that fits in a user's hand. Video see-through techniques are used to overlay the graphical information to the physical world. In some examples, rather than a user wearing or carrying a display such as with head mounted displays or handheld devices, Spatial Augmented Reality (SAR) uses digital projectors to display graphical information onto physical objects. An SAR system can be used by multiple people at the same time without each having to wear a head mounted display. SAR can support a graphical visualization and passive haptic sensation for end user(s).

Augmented reality image registration uses different methods of computer vision, mostly related to video tracking. Many computer vision methods of augmented reality are inherited from similar visual odometry methods. For example, interest points, fiduciary markers, and/or optical flow are detected in camera images. Feature detection methods such as corner detection, blob detection, edge detection, and/or thresholding and/or other image processing methods can be used to process the image data. Then, a real world coordinate system is restored based on the obtained camera image data.

Augmented reality technology is used to add pertinent patient data next to the patient's face in real time (or substantially real time). Pertinent patient data can include information such as the patient's name, reason for visit (if pre-scheduled), attending physician, insurance information, history, etc. When the receptionist selects the patient data using a pointing device, the system launches a user interface dialog to proceed with a patient registration process.

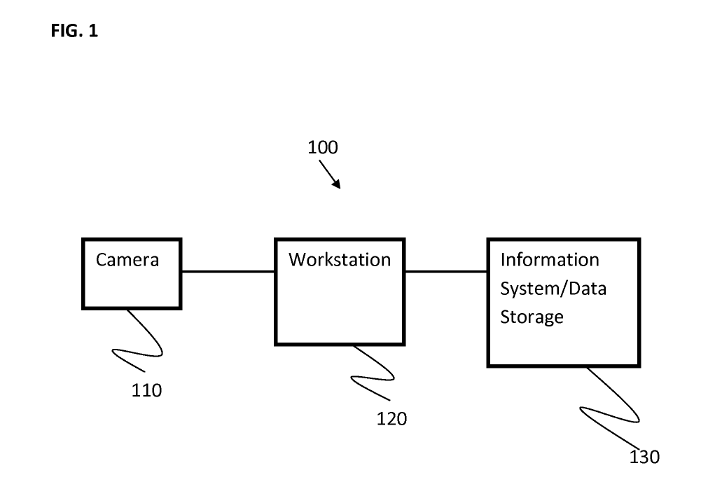

FIG. 1 illustrates an example patient registration system 100 using augmented reality and facial recognition to facilitate patient registration at a healthcare facility. The system 100 includes a camera 110, a computer workstation 120, and an information system/data storage 130. The camera 110 is coupled to the workstation 120 to provide a live feed to the workstation 120 in a healthcare facility (e.g., a reception or waiting room). When a patient enters the field of view of the camera 110, the patient's image is captures. The workstation 120 performs facial recognition on the patient image to identify the patient. Once the patient has been identified, information regarding the patient is retrieved from the information system/data storage 130 for display on the workstation 120. The workstation 120 can be used to check in the patient and/or complete additional electronic forms. The completed information can be provided back to the information system/data storage 130, for example.

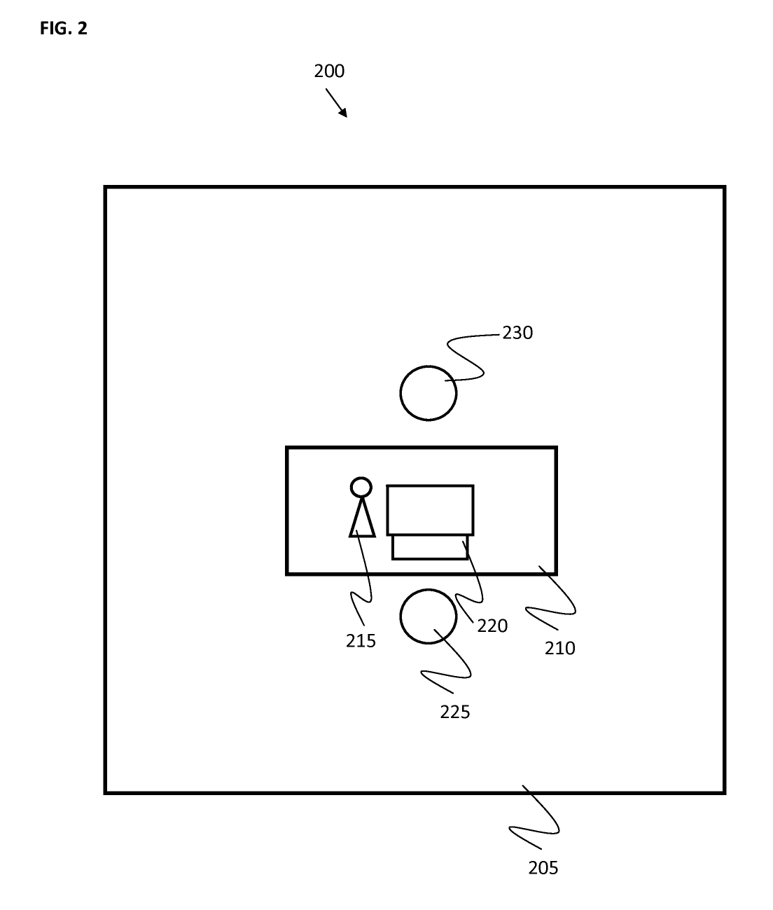

FIG. 2 depicts an example healthcare facility 200. The facility 200 includes a reception area 205, a reception desk 210, a camera 215, a computer workstation 220, a receptionist 225, and a patient 230. The patient 230 approaches the desk 210 and stands in view of the camera 215. The camera 215 is connected to the computer 220 and transmits still and/or motion image data to the computer 220 for viewing by the receptionist 225 and processing by the computer 220. The field of view of the camera 215 can cover all or part of the reception area 205. Once the computer 220 has identified the patient 230 based on the feed from the camera 215, patient information is retrieved and displayed on the computer 220 display in conjunction with the patient image from the camera 215. A check-in and/or other application, document, and/or user interface dialog can be opened at the computer 220 for completion by the receptionist 225 while he or she is facing the patient 230, for example.

In some examples, a plurality of patients 230 are within the camera 215 field of view in the reception area 205. The patients 230 stand or sit in various locations around the reception area 205 or approach the reception desk 210. Facial recognition of each of the patients 230 can be determined in real time (or substantially in real time due to inherent processing delay), and the camera 215 and workstation 220 can track the patients 230 as they move around the reception area 205. Retrieved patient data shown on the computer 220 is linked to the particular patient 230 so that the receptionist 225 need only to glance at the patient's image on the computer 220 to see relevant data, which can include patient wait time as well as patient identifying, historical and/or appointment information. In some examples, the font size for the displayed data as well as the amount and type of data can change the closer or farther the patient 230 is from the receptionist 225, for example. By varying the level of detail based on patient 230 proximity to the camera 215 and receptionist 225, the receptionist 225 can view more detail for those patients 230 (e.g., identification and appointment information) near the reception desk 210 and less detail (e.g., name and wait time) for patients 230 sitting in the reception area 205 away from the desk 210.

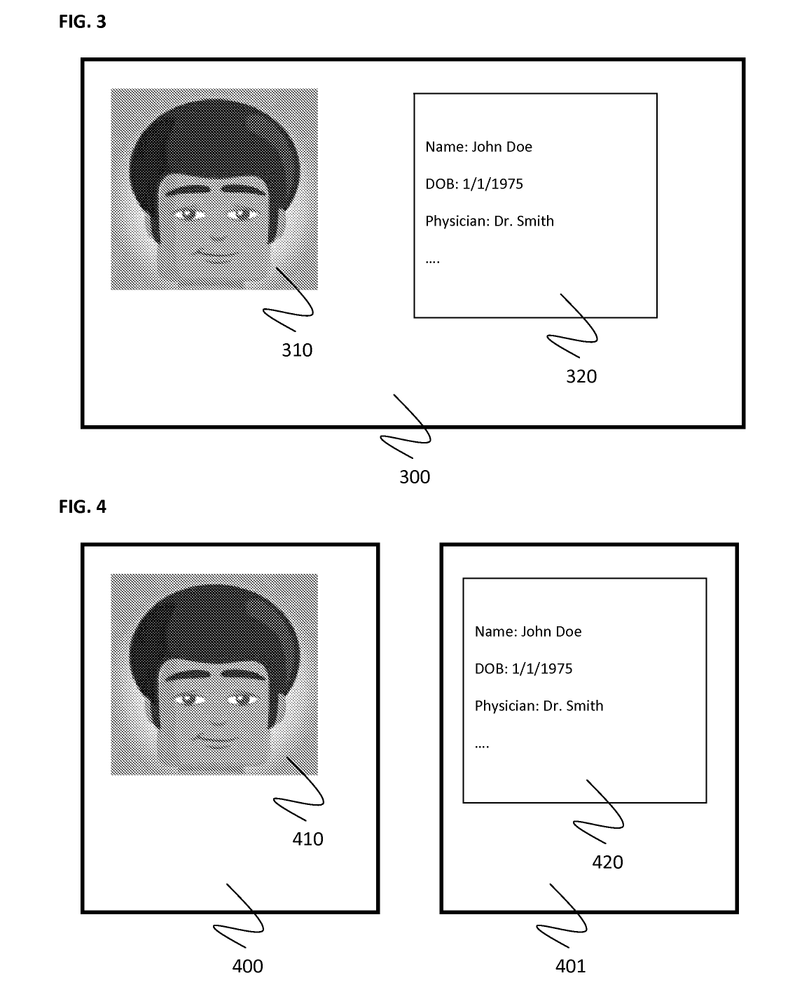

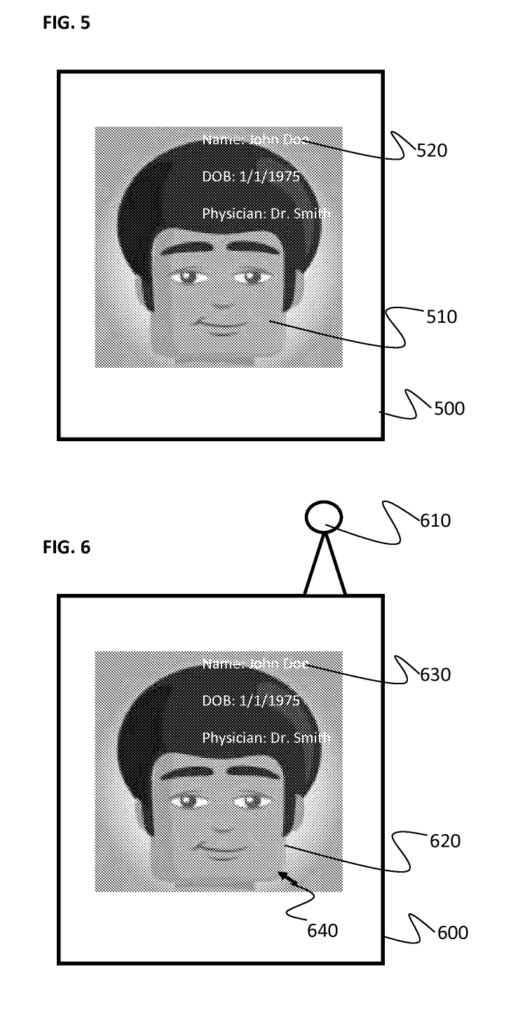

FIGS. 3-6 show various monitor configurations using facial recognition and augmented reality for patient identification. In FIG. 3, for example, a monitor and/or other computer display 300 can show a patient image 310 and also show patient information 320 adjacent to the image 310 on the screen 300. In FIG. 4, a dual monitor setup 400, 401 shows a patient image 410 on the first monitor 400 and patient information 420 on the second monitor 401. In FIG. 5, a display 500 is configured to show patient information 520 superimposed over at least a portion of a patient image 510 (e.g., a live video feed of the patient). Patient information 520 and/or application information (e.g., a registration or check-in screen or dialog box) can be shown in conjunction with the patient image 510 by differentiating one or more colors of the information 520 displayed, providing a projected or 3D effect, etc. FIG. 6 illustrates an example monitor 600 configuration including a camera 610 mounted on the monitor 600 to provide a patient image 620 for display on the monitor 600. Patient information 630 is provided in conjunction with the image 620 and can overlay at least a portion of the image 620, for example. A cursor 640 can be used to select the patient image 620, patient information 630, etc., to select and/or trigger an action. For example, a user can select the patient image 620 to initiate registration or check in of the patient based on the retrieved patient information 630 for the identified patient. In an example, multiple patients can be tracked such that multiple patient images 620 are shown on the screen 600. The user can then select an image 620 corresponding to a desired patient for action. In an example, a primary image 620 can be provided based on a patient in closest proximity to the camera 610. Using augmented reality, patient data and check-in functionality can remain available for selection as long as the patient is in view of the camera 610, regardless of patient position.

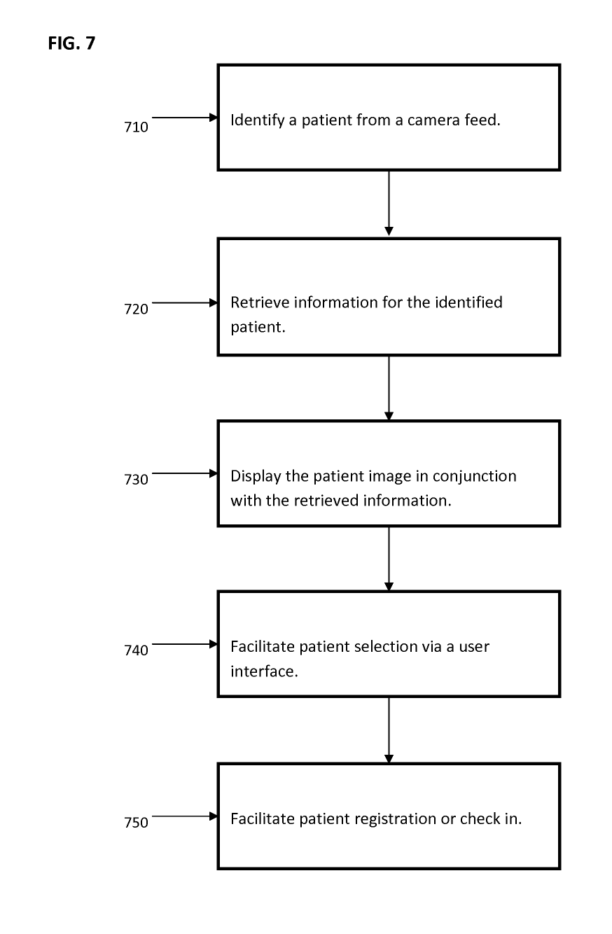

FIG. 7 shows a flow diagram for an example method 700 for patient identification and registration. At 710, a patient is identified from a camera image feed. For example, a patient walks into an emergency room, and an image of the patient is captured by a triage desk camera. Using facial recognition techniques, such as those described above, the patient is identified from the image/video feed.

At 720, information is retrieved for the identified patient. For example, a radiology information system (RIS), electronic medical records system (EMR), picture archiving and communications system (PACS), scheduling system, clinical order system, and/or other healthcare information and/or processing system can be queried to retrieve appointment(s), record(s), and/or other information regarding the patient.

At 730, the patient's image is shown in conjunction with the retrieved patient information. For example, a camera feed of the patient's face is shown on the triage nurse's computer in conjunction patient identifying and/or history information displayed over the patient image, next to the patient image, on a secondary display, etc.

At 740, the patient is selected via the user interface. For example, the nurse can click on (e.g., using a mouse or touchscreen) and/or otherwise select the patient's image and/or associated information. At 750, the patient is checked in. For example, selecting the patient can automatically launch a registration or check in application to register or check in the patient. In some examples, the retrieved information can be used to auto-populate the registration or check in form.

As described herein, the method 700 can be implemented using one or more combinations of hardware, software, and/or firmware, for example. The method 400 can operate in conjunction with one or more external systems (e.g., data sources, healthcare information systems (RIS, PACS, CVIS, HIS, etc.), archives, imaging modalities, etc.). One or more components of the method 700 can be reordered, eliminated, and/or repeated based on a particular implementation, for example.

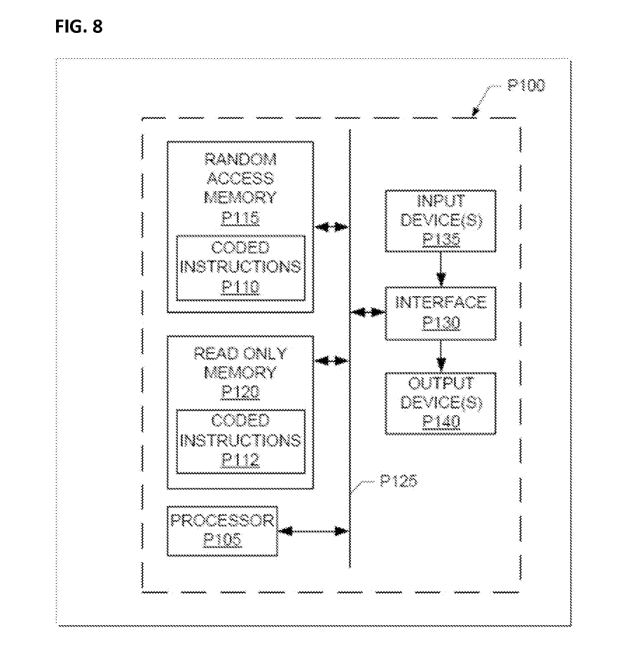

FIG. 8 is a schematic diagram of an example processor platform P100 that can be used and/or programmed to implement the example systems and methods described above. For example, the processor platform P100 can be implemented by one or more general-purpose processors, processor cores, microcontrollers, etc.

The processor platform P100 of the example of FIG. 8 includes at least one general-purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example process of FIG. 7 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown). The example memory P115 may be used to implement the example databases described herein.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130. The input devices P135 may be used to, for example, receive patient documents from a remote server and/or database. The example output devices P140 may be used to, for example, provide patient documents for review and/or storage at a remote server and/or database.

Thus, certain examples provide improved systems and methods for patient identification and registration. Certain examples allow a user to remain facing the patient while identifying and checking in that patient. Certain examples use facial recognition and augmented reality to improve the amount and quality of information available to a workstation user.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A patient identification system, the system comprising:
a data storage to store patient information including patient identifying information associated with one or more patient images;
a processor adapted to facilitate identification of a patient, the processor to:
receive a camera feed including an image of a patient;
perform facial recognition using the camera feed to identify the patient in comparison with information stored in the data storage;
retrieve information associated with the identified patient from the patient storage;
display the retrieved information in conjunction with the image of the identified patient on a computer screen; and
facilitate an electronic action with respect to the identified patient via the computer.

2. The system of claim 1, wherein the information is superimposed over the image of the patient.

3. The system of claim 1, wherein the image of the patient is provided on a primary display and the information is provided on a secondary display.

4. The system of claim 1, wherein the electronic action comprises electronic registration of the patient.

5. The system of claim 1, wherein the electronic action comprises electronic check in of the patient for an appointment.

6. The system of claim 1, wherein the camera feed comprises a live video feed from a camera to the processor.

7. The system of claim 6, wherein the camera and the workstation are oriented such that a user of the workstation faces the patient while operating the workstation to identify and register the patient.

8. A computer-implemented method for patient identification, the method comprising:
receiving, using a processor, an image feed from a camera including an image of a patient;
performing, using a processor, facial recognition using the image feed to identify the patient in comparison with information stored in a data storage, wherein the image feed data is transformed into a patient identification;
retrieving, using a processor, information associated with the identified patient from the patient storage;
displaying, using a processor, the retrieved information in conjunction with the image of the identified patient on a computer screen; and
facilitating, using a processor, an electronic action with respect to the identified patient.

9. The method of claim 8, wherein the information is superimposed over the image of the patient.

10. The method of claim 8, wherein the image of the patient is provided on a primary display and the information is provided on a secondary display.

11. The method of claim 8, wherein the electronic action comprises electronic registration of the patient.

12. The method of claim 8, wherein the electronic action comprises electronic check in of the patient for an appointment.

13. The method of claim 8, wherein the camera feed comprises a live video feed from a camera to the processor.

14. The system of claim 13, wherein the camera and the workstation are oriented such that a user of the workstation faces the patient while operating the workstation to identify and register the patient.

15. A computer-readable storage medium having a set of instructions stored thereon which, when executed, instruct a processor to implement a method for patient identification, the method comprising:
receiving an image feed from a camera including an image of a patient;
performing facial recognition using the image feed to identify the patient in comparison with information stored in a data storage, wherein the image feed data is transformed into a patient identification;
retrieving information associated with the identified patient from the patient storage;
displaying the retrieved information in conjunction with the image of the identified patient on a computer screen; and
facilitating an electronic action with respect to the identified patient.

16. The computer-readable storage medium of claim 15, wherein the information is superimposed over the image of the patient.

17. The computer-readable storage medium of claim 15, wherein the image of the patient is provided on a primary display and the information is provided on a secondary display.

18. The computer-readable storage medium of claim 15, wherein the electronic action comprises electronic registration of the patient.

19. The computer-readable storage medium of claim 15, wherein the electronic action comprises electronic check in of the patient for an appointment.

20. The computer-readable storage medium of claim 15, wherein the camera feed comprises a live video feed from a camera to the processor.
